(19) United States
(12) Patent Application Publication
(10) Pub. No.: US 2022/0332240 A1
(43) Pub. Date: Oct. 20, 2022

(54) RAMP-EQUIPPED VEHICLE

(71) Applicants: TOYOTA JIDOSHA KABUSHIKI KAISHA, Toyota-shi (JP); AISIN CORPORATION, Kariya (JP)

(72) Inventors: Junya FUKUTA, Nagoya-shi (JP); Kentaro OYA, Toyota-shi (JP); Isao HONDA, Kariya-shi (JP); Naoya ISHIDA, Kariya-shi (JP); Chihiro DATE, Kariya-shi (JP); Yuji NISHI, Kariya-shi (JP); Takeshi NISHIKIBE, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 17/716,227

(22) Filed: Apr. 8, 2022

(30) Foreign Application Priority Data
Apr. 20, 2021 (JP) 2021-071023

(51) Int. Cl. B60P 1/43

(52) U.S. Cl. CPC B60P 1/431

(57) ABSTRACT

A ramp-equipped vehicle includes a ramp that is provided so as to be deployable from a side portion of a vehicle body to the outside of the vehicle body, a controller that controls the operation of deploying the ramp, and a sensor that senses moving bodies present in a certain area that is away from a ramp deployment area. The controller detects the moving bodies approaching the ramp deployment area and determines the moving velocities of the moving bodies based on the results of sensing by the sensor. The controller stops the operation of deploying the ramp when, after the start of the operation of deploying the ramp, it detects the approaching moving body having a moving velocity higher than or equal to a predetermined reference velocity with which the approaching moving bodies may reach the ramp deployment area during the operation of deploying the ramp.

### CROSS REFERENCE TO RELATED APPLICATION

This application claims priority to Japanese Patent Application No. 2021-071023 filed on Apr. 20, 2021, which is incorporated herein by reference in its entirety including the specification, claims, drawings, and abstract.

### TECHNICAL FIELD

The present disclosure relates to a ramp-equipped vehicle and in particular to a ramp-equipped vehicle with a ramp deployed from a side portion of a vehicle body to the outside of the vehicle body.

### BACKGROUND

A ramp-equipped vehicle has a ramp that is deployable from the vehicle to a sidewalk, road, and the like so that a wheelchair, stroller, large carry cart, and the like can easily enter the vehicle from the sidewalk, the road, and the like. The ramp is deployed from the underside of a doorway at a side portion of the vehicle body to the outside of the vehicle body, for example.

Patent Document 1 discloses a door apparatus that restricts the action of opening a door based on the operation of opening the door by an occupant in the vehicle upon detection of a moving body approaching the vehicle door. The door apparatus according to the above document allows the door opening action if the door opening operation is performed by the occupant a predetermined plurality of times while the door opening action is restricted. The door apparatus thus improves the convenience for the occupant while ensuring security.

### CITATION LIST

### Patent Literature

Patent Document 1: JP 2018-69769 A

### SUMMARY

While the ramp-equipped vehicle parked on the road is deploying the ramp from the side portion of the vehicle body to the outside of the vehicle body, a moving body may pass by the side of the vehicle body on the side where the ramp is being deployed. In this case, there is a risk that the ramp that is being deployed comes close to the moving body approaching it.

An object of the present disclosure is to prevent the ramp that is being deployed from the side portion of the vehicle body to the outside of the vehicle body from coming close to the moving body approaching it.

A ramp-equipped vehicle according to the present disclosure has a ramp that is provided so as to be deployable from a side portion of a vehicle body to the outside of the vehicle body, a controller that controls the operation of deploying the ramp, and a sensor that senses a moving body present in at least one of a certain area that is away from a deployment area of the ramp in the vehicle forward direction and a certain area that is away from the deployment area of the ramp in the vehicle rearward direction, and in this vehicle, the controller detects an approaching moving body approaching the deployment area of the ramp and determines the moving velocity of the approaching moving body based on the results of sensing by the sensor, and stops the operation of deploying the ramp when, after the start of the operation of deploying the ramp, the controller detects the approaching moving body as having a moving velocity higher than or equal to a predetermined reference velocity with which the approaching moving body may reach the deployment area of the ramp during the operation of deploying the ramp.

In the ramp-equipped vehicle according to the present disclosure, the controller may further control the operation of storing the ramp and may stop the operation of deploying the ramp and then start the operation of storing the ramp when the controller detects the approaching moving body as having a moving velocity higher than or equal to another predetermined reference velocity higher than the reference velocity during the operation of deploying the ramp.

The ramp-equipped vehicle according to the present disclosure may further have a speaker that is positioned on an outer surface of the vehicle body so as to output a sound toward at least one of the certain area that is away from the deployment area of the ramp in the vehicle forward direction and the certain area that is away from the deployment area of the ramp in the vehicle rearward direction, and the controller may generate a beep sound from the speaker when it detects the approaching moving body as having a moving velocity higher than or equal to the reference velocity during the operation of deploying the ramp.

According to the present disclosure, upon detection of a moving body that may reach a ramp deployment area during the ramp deployment operation, the operation of deploying the ramp is stopped. It is thus possible to prevent the ramp from coming close to the moving body approaching it, unlike the case where the deployment operation is continued.

### BRIEF DESCRIPTION OF DRAWINGS

An embodiment of the present disclosure will be described based on the following figures, wherein:

FIG. 1 is a perspective view of a vehicle according to an embodiment;

FIG. 2 is a perspective view showing a ramp deployed as a door of the vehicle is opened;

FIG. 3 is a diagram showing the vicinity of a doorway in an interior of the vehicle;

FIG. 4 is a schematic diagram showing the vehicle and its surrounding area viewed from above;

FIG. 5 is a functional block diagram of a ramp control system of the vehicle;

FIG. 6 is a table for explaining ramp control and speaker control by a controller;

FIG. 7 is a diagram for illustrating the operation of the ramp when a low-velocity moving body is detected;

FIG. 8 is a diagram for illustrating the operation of the ramp when a medium-velocity moving body is detected; and

FIG. 9 is a diagram for illustrating the operation of the ramp when a high-velocity moving body is detected.

### DESCRIPTION OF EMBODIMENTS

Hereinafter, an embodiment of the present disclosure will be described with reference to the drawings. The arrangements described below are merely examples for illustration and may be changed according to specifications or other requirements of a vehicle. In addition, when a plurality of embodiments and variations are included in the description below, it is assumed from the beginning that their characteristic portions are used in appropriate combinations. Throughout the drawings, the same elements are denoted by the same reference numerals, and redundant description will be omitted. In the following description, unless otherwise specified, terms indicating orientations and directions such as front, rear, left, right, up, and down indicate orientations and directions related to the vehicle. In each figure, the direction of arrow FR is forward, the direction of arrow UP is upward, and the direction of arrow LH is left.

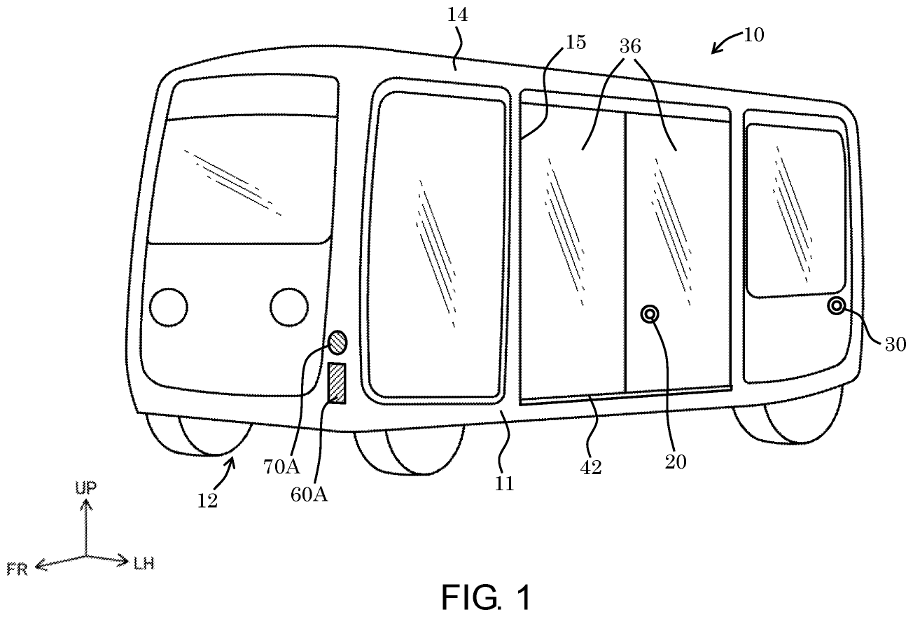

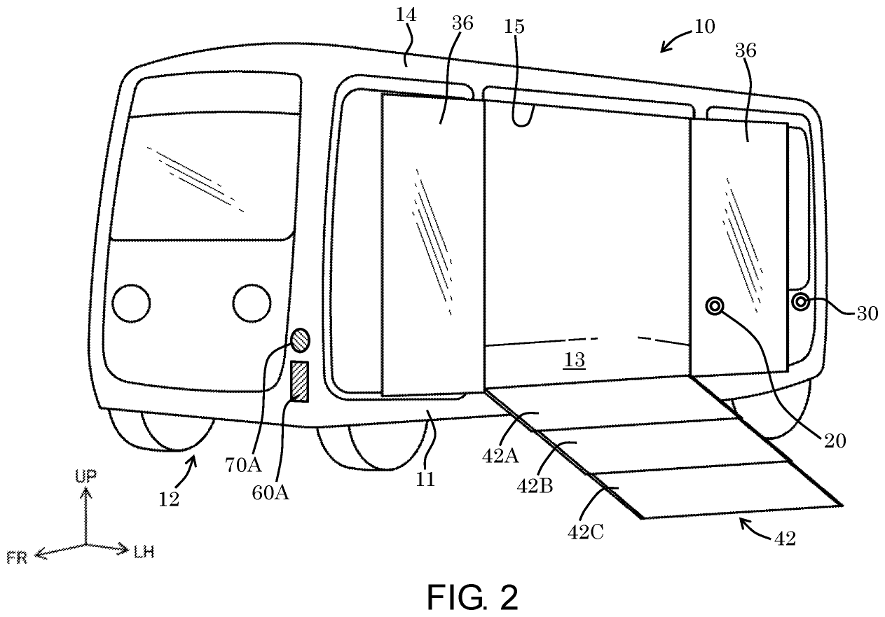

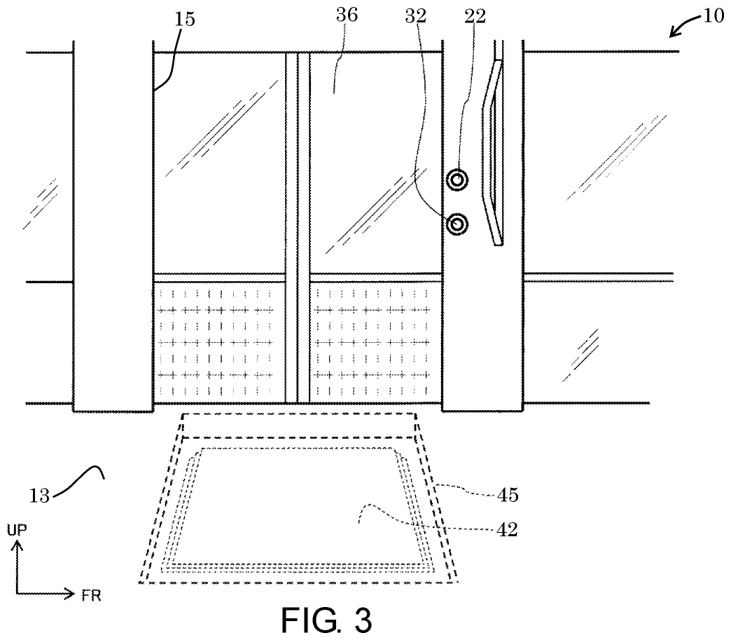

FIG. 1 is a perspective view of a vehicle 10 according to an embodiment. FIG. 2 is a perspective view showing a ramp 42 deployed as doors 36 of the vehicle 10 are opened. FIG. 3 is diagram showing the vicinity of a doorway 15 in an interior of the vehicle 10. FIGS. 2 and 3 depict the vehicle interior in a simplified manner.

As shown in FIG. 1, the vehicle 10 is an electric car having a generally rectangular solid shape and is capable of autonomous driving. Specifically, the vehicle 10 can be driven in a plurality of driving modes including an autonomous driving mode and a manual driving mode.

The vehicle 10 is used as a bus on which an unspecified large number of occupants can ride together. However, a type of use of the vehicle 10 may be changed as appropriate. For example, the vehicle 10 may be used as a store, such as, for example, a retail store for displaying and selling various types of goods or as a restaurant for cooking and serving foods and drinks. The vehicle 10 may also be used as an office for office work, for meeting with customers, and the like. The vehicle 10 may also be used as a taxi for transporting passengers or luggage, a delivery vehicle, and the like. The use of the vehicle 10 is not limited to business situations. For example, the vehicle 10 may be used as personal transportation means.

The vehicle 10 has a base frame 11 forming a skeleton of a lower vehicle body, a vehicle drive unit 12 mounted on the base frame 11, a floor panel 13 (see FIG. 2) provided on the upper side of the base frame 11 to form the floor of a vehicle interior, and a body 14 forming an outline of an upper vehicle body. The doorway 15 is formed in the left side portion of the vehicle body. The doorway 15 is located almost in the center along the front-and-rear direction and is closed by the doors 36 while the vehicle travels. The vehicle 10 is also equipped with the ramp 42 (see FIG. 2) that is deployed from the underside of the doorway 15 to the outside of the vehicle body. In its stored state, the ramp 42 is located in a gap between the base frame 11 and the floor panel 13.

Although, in the present embodiment, the doorway 15 is formed on the left side portion of the vehicle body, it may be formed on the right side portion or on both the right and left side portions of the vehicle body. The ramp 42 may be provided so as to be deployable from the right side portion or from both the right and left side portions of the vehicle body to the outside of the vehicle body according to the position of the doorway 15.

The doors 36 are sliding doors, and by operating a door button 20 or a door ramp button 30 on the outer surface of the vehicle body, or a door button 22 in the vehicle interior (see FIG. 3), the front side door 36 is moved forward, and the rear side door 36 is moved rearward, thereby opening the doorway 15.

As shown in FIG. 2, the ramp 42 includes, for example, three ramp plates 42A, 42B, and 42C. By operating the door ramp button 30 on the outer surface of the vehicle body or a ramp button 32 in the vehicle interior (see FIG. 3), the ramp 42 is deployed to the outside of the vehicle body. Specifically, when the door ramp button 30 or the ramp button 32 is pressed, the ramp plate 42A is first brought out, and the ramp plate 42B is then guided by the ramp plate 42A and brought out. Further, the ramp plate 42C is guided by the ramp plate 42B and brought out. Upon contact of a tip portion of the ramp plate 42C with the sidewalk, the road, or the like, the operation of deploying the ramp 42 ends.

As shown in FIG. 3, a storage portion 45 for storing the ramp 42 is provided under the floor panel 13 and in front of the doorway 15 (on the left side of the vehicle). The ramp 42 is deployed from the storage portion 45 to the outside of the vehicle body at the time of deployment and is returned into the storage portion 45 from the outside of the vehicle body at the time of storage.

The vehicle 10 has the two door buttons 20 and 22, the single door ramp button 30, and the single ramp button 32. Each of these buttons is a button (push button) serving as a switch which is closed or opened when it is pressed by a human finger or the like and enables detection of the button operation. As shown in FIG. 1, the door button 20 is provided on the outer surface of the door 36, and the door ramp button 30 is provided on the side surface of the vehicle body on the rear side of the doorway 15. The door ramp button 30 may be provided on the side surface of the vehicle body on the front side of the doorway 15. In addition, as shown in FIG. 3, the door button 22 and the ramp button 32 are provided on the wall near the doors 36 in the vehicle interior.

If either one of the door buttons 20 and 22 is pressed when the doors 36 are closed, the doors 36 are opened. If either one of the door buttons 20 and 22 is pressed when the doors 36 are open, the doors 36 are closed.

Also, by pressing the door ramp button 30 when the doors 36 are closed and the ramp 42 is stored, the doors 36 are opened, and the ramp 42 is deployed. By pressing the door ramp button 30 when the doors 36 are open and the ramp 42 is deployed, the doors 36 are closed, and the ramp 42 is stored.

Further, by pressing the ramp button 32 when the ramp 42 is stored, the ramp 42 is deployed. By pressing the ramp button 32 when the ramp 42 is deployed, the ramp 42 is stored.

A passenger outside the vehicle who wants to use the ramp 42 presses the door ramp button 30 to open the doors 36 and deploy the ramp 42, thereby getting into the vehicle 10 together with a wheelchair, stroller, large carry cart, or the like. Also, a passenger in the vehicle interior who wants to use the ramp 42 presses both the door button 22 and the ramp button 32 to open the doors 36 and deploy the ramp 42, thereby getting off the vehicle 10 together with a wheelchair, stroller, large carry cart, or the like.

Here, as shown in FIG. 1, the vehicle 10 is provided with an object sensing sensor 60A and a speaker 70A on the left end portion of the front surface of the vehicle body. The object sensing sensor 60A and the speaker 70A are aligned vertically and arranged at a relatively low position on the vehicle body.

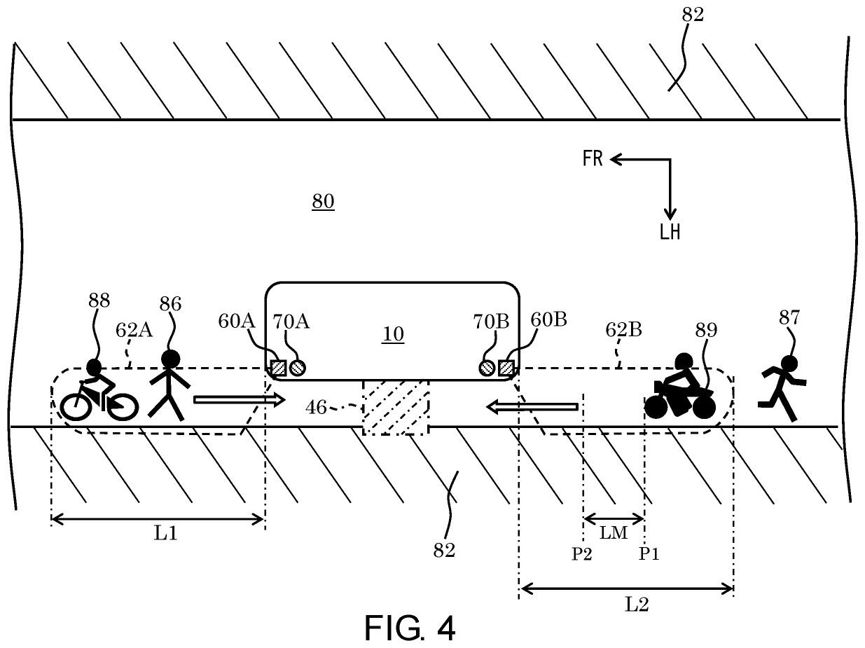

FIG. 4 is a schematic diagram showing the vehicle 10 parked on a road 80 and its surrounding area viewed from above. This diagram depicts the vehicle 10 which is about to deploy the ramp to a sidewalk 82 and an area 46 to which the ramp is to be deployed (hereinafter, referred to as a ramp deployment area 46). The vehicle 10 is also provided with an object sensing sensor 60B and a speaker 70B on the left end portion of the rear surface of the vehicle body. Like those on the front surface of the vehicle body, the object sensing sensor 60B and the speaker 70B on the rear surface of the vehicle body are aligned vertically and arranged at a relatively low position on the vehicle body. In FIG. 4, for convenience of illustration, the positions of the speakers 70A and 70B are respectively shifted with respect to the object sensing sensors 60A and 60B in the vehicle front-rear direction.

The object sensing sensor 60A is a sensor for sensing an object present in a certain area 62A that is away from the ramp deployment area 46 in the forward direction (area surrounded by a broken line 62A in FIG. 4). The object sensing sensor 60B is a sensor for sensing an object present in a certain area 62B away from the ramp deployment area 46 in the rearward direction (area surrounded by a broken line 62B in FIG. 4). In the present embodiment, the object sensing sensors 60A and 60B sense moving bodies present in the certain areas 62A and 62B, respectively. The moving bodies include, for example, a pedestrian 86, a runner 87, a bicycle 88, a motorcycle (auto-bicycle) 89, and the like. Hereinafter, the certain areas 62A and 62B will also be referred to as sensing areas 62A and 62B, respectively.

The sensing area 62A of the object sensing sensor 60A is an area extending on the front side of the ramp deployment area 46 up to a position away from the front surface of the vehicle body by a distance L1, and the distance L1 is 5 to 20 m, for example. In addition, the sensing area 62B of the object sensing sensor 60B is an area extending on the rear side of the ramp deployment area 46 up to a position away from the rear surface of the vehicle body by a distance L2, and the distance L2 is also 5 to 20 m, for example. The distances L1 and L2 may be the same or may be different from each other. In FIG. 4, for convenience of illustration, the lengths L1 and L2 of the sensing areas 62A and 62B are drawn slightly shorter compared to the total length of the vehicle 10.

The object sensing sensors 60A and 60B are composed of, for example, any one of a camera (including a stereo camera), Lidar, a millimeter wave radar, an ultrasonic sensor, and the like, or a combination of two or more of them. The object sensing sensors 60A and 60B are not limited to the sensors listed above. Hereinafter, the object sensing sensor 60A will be simply referred to as the sensor 60A or the front side sensor 60A, and the object sensing sensor 60B will be simply referred to as the sensor 60B or the rear side sensor 60B.

As described below, in the present embodiment, a controller detects a moving body approaching the ramp deployment area 46 (referred to as an approaching moving body) based on the results of sensing by the sensors 60A and 60B (positions of the moving body).

The speaker 70A is a device for outputting a sound toward a moving body present in the certain area 62A away from the ramp deployment area 46 in the forward direction. The speaker 70B is a device for outputting a sound toward a moving body present in the certain area 62B away from the ramp deployment area 46 in the rearward direction. Hereinafter, the speaker 70A will also be referred to as the front side speaker 70A. The speaker 70B will also be referred to as the rear side speaker 70B.

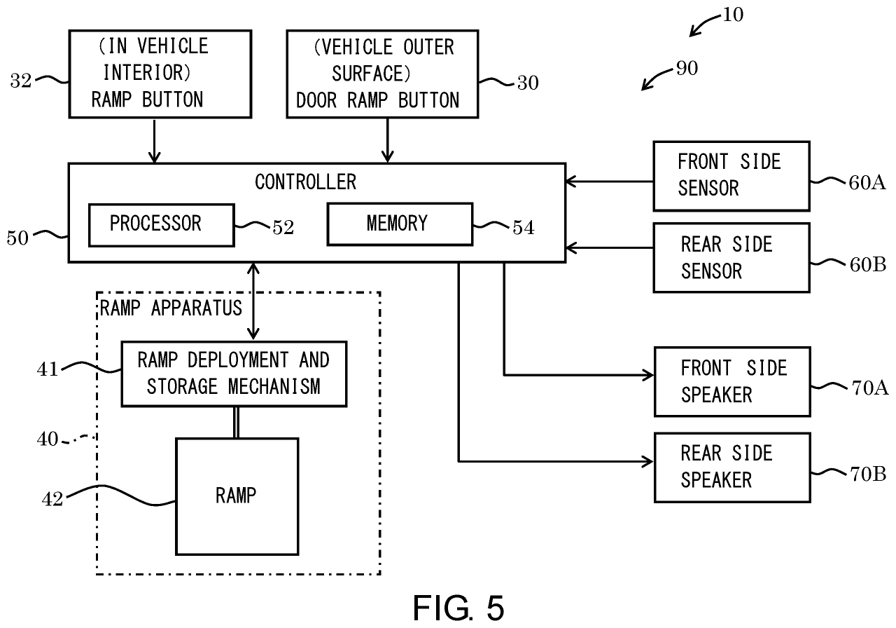

FIG. 5 is a functional block diagram of a ramp control system 90 of the vehicle. The vehicle 10 is provided with the ramp control system 90 and a ramp apparatus 40.

The ramp control system 90 has the door ramp button 30, the ramp button 32, a controller 50, the front side sensor 60A, the rear side sensor 60B, the front side speaker 70A, and the rear side speaker 70B.

The controller 50 includes a processor 52 having a CPU and a memory 54 that stores a control program, control data, and the like. The memory 54 is, for example, a RAM, a ROM, a flash memory, or the like. The processor 52 operates according to the control program stored in the memory 54 to thereby control the ramp apparatus 40, detect an approaching moving body and its moving velocity, and control the speakers 70A and 70B. The processor 52 may include an Application Specific Integrated Circuit (ASIC) and the like instead of or together with the CPU. The controller 50 may also include a plurality of processors that are physically separated from each other. The controller 50 may be composed of a combination of a ramp control section (controller for controlling the ramp apparatus 40), an approaching moving body detection section (computer for detecting an approaching moving body and its moving velocity), and a speaker control section (controller for controlling the speakers 70A and 70B) that are physically separated from each other.

The ramp apparatus 40 includes the ramp 42 and a ramp deployment and storage mechanism 41 that is an actuator for deploying and storing the ramp 42.

The controller 50 is electrically connected to the door ramp button 30, the ramp button 32, the ramp deployment and storage mechanism 41 of the ramp apparatus 40, the front side sensor 60A, the rear side sensor 60B, the front side speaker 70A, and the rear side speaker 70B.

Control of the ramp 42, detection of an approaching moving body, and control of the speakers 70A and 70B by the controller 50 will now be described. Upon receipt of instructions to deploy the ramp based on pressing of the door ramp button 30 or the ramp button 32 when the ramp 42 is in its stored state, the controller 50 controls the ramp deployment and storage mechanism 41 to deploy the ramp 42 to the outside of the vehicle body. Upon receipt of instructions to store the ramp based on pressing of the door ramp button 30 or the ramp button 32 when the ramp 42 is in its deployed state, the controller 50 controls the ramp deployment and storage mechanism 41 to store the ramp 42 in the vehicle body.

Immediately after starting the operation of deploying the ramp 42 according to the ramp deployment instructions, the controller 50 detects an approaching moving body approaching the deployment area 46 and its moving velocity. Specifically, as shown in FIG. 4, the controller 50 obtains, from the sensor 60B, a position P1 of the moving body 89 present in the sensing area 62B and a position P2 of the same moving body 89 after the elapse oft seconds and determines whether or not the moving body 89 is approaching the ramp deployment area 46, from the two positions P1 and P2 of the moving body 89 in the sensing area 62B. More specifically, when the position P2 is located on the ramp deployment area 46 side with respect to the position P1 as shown in FIG. 4, the controller 50 recognizes the moving body 89 as an approaching moving body. On the other hand, when the position P2 is located on the side farther from the ramp deployment area 46 (vehicle 10) compared to the position P1, the controller 50 recognizes the moving body as not an approaching moving body. When a plurality of moving bodies are present in the sensing area 62B, the controller 50 detects whether or not each of them is an approaching moving body.

This process also applies to moving bodies present in the sensing area 62A of the sensor 60A. That is, the controller 50 obtains, from the sensor 60A, positions P1 (not shown) of the moving bodies 86 and 88 present in the sensing area 62A and positions P2 (not shown) of the same moving bodies 86 and 88 after the elapse oft seconds and determines whether or not the moving bodies 86 and 88 are approaching the ramp deployment area 46 (whether or not the moving bodies 86 and 88 are approaching moving bodies), from the two positions P1 and P2 for each of the moving bodies 86 and 89 in the sensing area 62A. In the example shown in FIG. 4, the controller 50 recognizes the moving bodies 86 and 89 as approaching moving bodies and recognizes the moving body 88 as not an approaching moving body.

The controller 50 then determines the moving velocity my for each approaching moving body. Specifically, as shown in FIG. 4, the controller 50 divides the distance LM (amount of movement LM) between the positions P1 and P2 of the approaching moving body 89 by time t, thereby determining the moving velocity my of the approaching moving body 89. In the example shown in FIG. 4, the moving velocity my is determined for each of the two approaching moving bodies 86 and 89.

Then, based on the moving velocity my of the approaching moving bodies, the controller 50 controls the operation of deploying the ramp 42 and controls the speakers 70A and 70B. When a plurality of approaching moving bodies are detected like the approaching moving bodies 86 and 89 in the example of FIG. 4, the controller 50 controls the operation of deploying the ramp 42 and the speakers 70A and 70B based on the moving velocity my of the approaching moving body having the fastest velocity my (for example, the motorcycle 89 in FIG. 4).

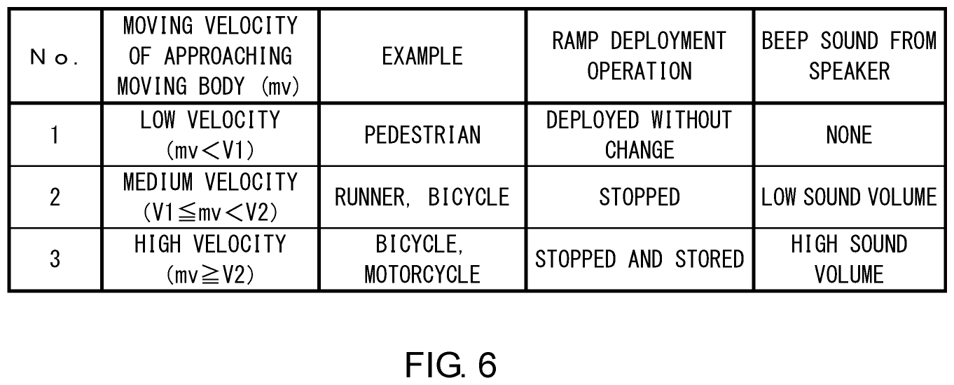

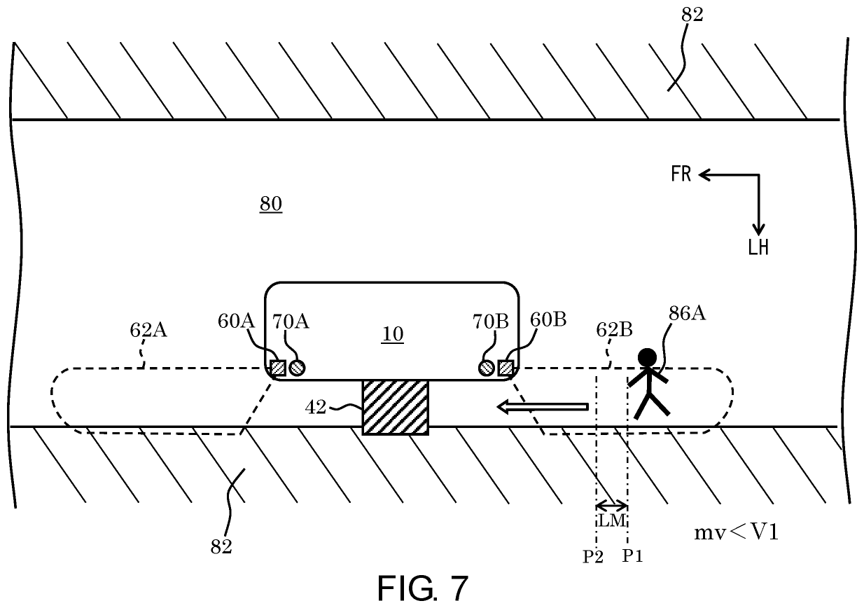

FIG. 6 is a table indicating control of the operation of deploying the ramp 42 and control of the speakers 70A and 70B performed by the controller 50 based on the moving velocity my of the approaching moving body. When the moving velocity my of the approaching moving body is lower than a predetermined reference velocity V1 (see No. 1 in FIG. 6, low velocity case), the controller 50 continues the operation of deploying the ramp 42 and does not generate a beep sound from the speaker 70A or the speaker 70B. This applies to the case where, for example, a pedestrian 86A is detected as an approaching moving body, as shown in FIG. 7. FIG. 7 shows the pedestrian 86A attempting to pass by the side of the vehicle body on the side where the ramp 42 is to be deployed (left side of the vehicle body) and the ramp 42 which continues to be deployed and completes deployment.

Here, the predetermined reference velocity V1 is a velocity with which the detected approaching moving body may reach the ramp deployment area during the operation of deploying the ramp 42. V1 is, for example, the velocity set such that an approaching moving body which is present at the center position along the vehicle front-rear direction in the sensing area 62B at the timing when the operation of deploying the ramp 42 is started continues to move at the velocity V1 (reference velocity) and reaches the ramp deployment area at the timing when the operation of deploying the ramp 42 is completed. V1 is, for example, about 7 km/h, but this is not limiting.

As shown in FIG. 7, when the moving velocity my of the approaching moving body 86A is lower than the reference velocity V1 (low velocity case), the approaching moving body 86A does not reach the deployment area during the operation of deploying the ramp 42. Even if the approaching moving body 86A reaches the deployment area, it can easily avoid coming close to the ramp 42, as it is slow. As such, the controller 50 preferentially performs the operation of deploying the ramp 42. In this manner, without cease of the operation of deploying the ramp 42 (described below), a passenger who wants to use the ramp 42 (for example, a passenger who pressed the door ramp button 30 on the outer surface of the vehicle body or the ramp button 32 in the vehicle interior) can use the ramp 42 promptly.

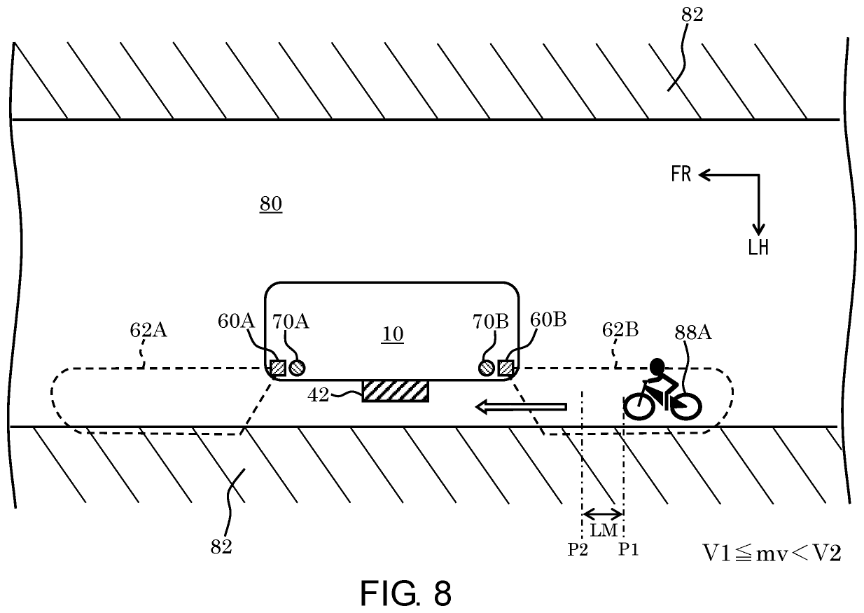

On the other hand, when the moving velocity my of the approaching moving body is higher than or equal to the predetermined reference velocity V1, and when it is lower than another predetermined reference velocity V2 (see No. 2 in FIG. 6, medium velocity case), the controller 50 stops the operation of deploying the ramp 42 and generates a beep sound from the speakers 70A and 70B. The beep sound in this case is a sound lower in volume than a beep sound used when the moving velocity my of the approaching moving body is higher than or equal to V2 (high velocity case), which will be described later. This applies to the case where, for example, a bicycle 88A is detected as an approaching moving body, as shown in FIG. 8. FIG. 8 shows the bicycle 88A attempting to pass by the side of the vehicle body on the side where the ramp 42 is to be deployed (left side of the vehicle body) and the ramp 42 which has stopped deploying accordingly. V2 is, for example, about 20 km/h, but this is not limiting.

As shown in FIG. 8, when the moving velocity my of the approaching moving body 88A is higher than or equal to V1 and lower than V2 (medium velocity case), the approaching moving body 88A is highly likely to reach the ramp deployment area during the operation of deploying the ramp 42. Therefore, the controller 50 stops the operation of deploying the ramp 42, thereby preventing the ramp 42 from coming close to the approaching moving body 88A that would reach the deployment area. Further, at this time, the controller 50 generates a beep sound from the speakers 70A and 70B, thereby allowing the approaching moving body 88A to recognize that the ramp 42 is being deployed. The approaching moving body 88A can thus obtain an opportunity to actively apply the brakes to prevent itself from coming close to the ramp deployment area.

Concerning the beep sound, its sound data are stored in the memory 54 of the controller 50 in advance. The processor 52 reads and reproduces the sound data from the memory 54, thereby outputting the beep sound from the speakers 70A and 70B. This process also applies to the case where the approaching moving body approaches at a high velocity as described below.

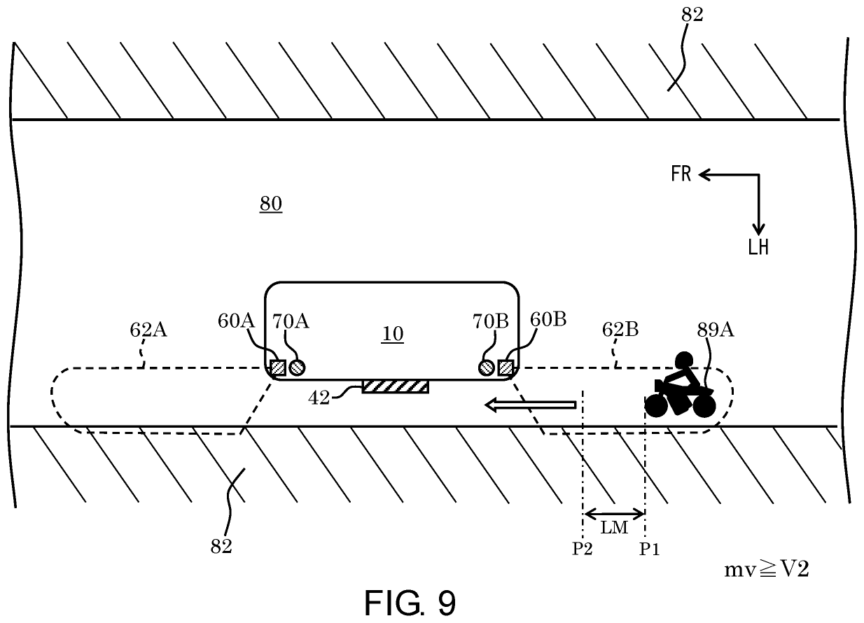

When the moving velocity my of the approaching moving body is higher than or equal to V2 (No. 3 in FIG. 6, high velocity case), the controller 50 stops the operation of deploying the ramp 42 and then starts the operation of storing the ramp 42. The controller 50 also generates a beep sound from the speakers 70A and 70B. The beep sound in this case is a sound louder than the beep sound used when the moving velocity my of the approaching moving body is medium as described above. This applies to the case where, for example, a motorcycle 89A is detected as the approaching moving body, as shown in FIG. 9. FIG. 9 shows the motorcycle 89A attempting to pass by the side of the vehicle body on the side where the ramp 42 is to be deployed (left side of the vehicle body) and the ramp 42 which stopped deploying accordingly and has just started to be stored.

As shown in FIG. 9, when the moving velocity my of the approaching moving body 89A is higher than or equal to V2 (high velocity case), the approaching moving body 89A may reach the ramp deployment area at a relatively high velocity during the operation of deploying the ramp 42. The controller 50 therefore stops the operation of deploying the ramp 42 and then starts the operation of storing it. It is thus possible to prevent the ramp 42 from coming close to the approaching moving body 89A which would reach the ramp deployment area, to a greater extent as compared to the case where the controller 50 does not start the operation of storing the ramp 42. Further, the controller 50 generates a beep sound that is relatively loud from the speakers 70A and 70B, thereby allowing the approaching moving body 89A approaching at a high velocity to recognize that the ramp 42 is being deployed. The approaching moving body 89A can thus obtain an opportunity to actively apply the brakes to prevent itself from being close to the ramp deployment area.

With the ramp control system 90 of the present embodiment described above, it is possible to stop the operation of deploying the ramp 42 upon detection of an approaching moving body approaching at a medium velocity. It is further possible to stop the operation of deploying the ramp 42 and then start the operation of storing it upon detection of an approaching moving body approaching at a high velocity. It is thus possible to prevent the ramp 42 from coming close to the approaching moving body approaching at a medium or high velocity. In addition, the ramp control system 90 generates a beep sound toward the moving body approaching at a medium or high velocity, and it is thus possible to prevent the approaching moving body from coming close to the ramp deployment area. On the other hand, for an approaching moving body approaching at a low velocity, the ramp control system 90 continues the operation of deploying the ramp 42, and a passenger of the vehicle 10 or the like can thus use the ramp 42 promptly.

Variations will now be described.

The controller 50 may obtain positions of the same approaching moving body from the sensors 60A and 60B three or more times at a time interval, thereby determining the moving velocity of the same approaching moving body a plurality of times. The controller 50 may then control the ramp 42 based on the determination results. For example, for the same approaching moving body, when the moving velocity my is higher than or equal to V2 (high velocity) at the first velocity determination, and when the moving velocity my is higher than or equal to the V1 and less than V2 (medium velocity) at the second velocity determination, the controller 50 may only stop the operation of deploying the ramp 42 (the operation of storing the ramp 42 is not performed). Further, when the moving velocity my of the approaching moving body becomes less than V1 (low velocity) at the third velocity determination, the controller 50 does not have to stop the operation of deploying the ramp 42 (the controller 50 may continue the operation of deploying the ramp 42). It is thus possible to avoid excessively restricting the operation of deploying the ramp 42 in consideration that the approaching moving body may apply the brakes, for example.

In addition, for example, for the same approaching moving body, when the moving velocity my is less than V1 (low velocity) at the first velocity determination, and when the moving velocity my is higher than or equal to the V1 and less than V2 (medium velocity) at the second velocity determination, the controller 50 may stop the operation of deploying the ramp 42. Further, when the moving velocity my of the same approaching moving body becomes higher than or equal to V2 (high velocity) at the third velocity determination, the controller 50 may stop the operation of deploying the ramp 42 and then start the operation of storing it. It is thus possible to prevent the ramp 42 from coming close to the approaching moving body appropriately even when the approaching moving body accelerates.

In the above embodiment, the sensors 60A and 60B are respectively arranged on both the front and rear portions of the vehicle. However, the sensor 60A (or 60B) may be provided on either one of the front and rear portions of the vehicle. Likewise, the speaker 70A (or 70B) may be provided on either one of the front and rear portions of the vehicle.

In addition, the beep sound output from the speakers 70A and 70B may be a voice indicating that the operation of deploying the ramp is being performed. For example, data of the voice are stored in the memory 54 of the controller 50 in advance, and the processor 52 reads and reproduces the voice data from the memory 54, thereby outputting the voice from the speakers 70A and 70B.

The controller 50 may also control the speaker 70A and the speaker 70B independently. That is, the controller 50 may control the presence/absence and volume of the beep sound from the front side speaker 70A according to the moving velocity my (low, medium, or high velocity in FIG. 6) of the approaching moving body present in the sensing area 62A of the front side sensor 70A (if there are a plurality of approaching moving bodies, the fastest one among them). Similarly, the controller 50 may control the presence/absence and volume of the beep sound from the rear side speaker 70B according to the moving velocity my (low, medium, or high velocity in FIG. 6) of the approaching moving body present in the sensing area 62B of the rear side sensor 70B (if there are a plurality of approaching moving bodies, the fastest one among them).

A speaker may also be installed on at least one of the outer surface of the vehicle body near the doorway 15 and the inner wall near the doorway 15 in the vehicle interior. This speaker outputs a voice indicating that, due to the approaching moving body, the operation of deploying the ramp 42 is being stopped, or that the operation of storing the ramp 42 is being carried out when one of these operations is performed. The occupants and the like can thus know that the operation of deploying the ramp 42 is being stopped, or that the operation of storing the ramp 42 is being carried out, and its reasons.

1. A ramp-equipped vehicle comprising:
a ramp that is provided so as to be deployable from a side portion of a vehicle body to the outside of the vehicle body;
a controller that controls the operation of deploying the ramp; and
a sensor that senses a moving body present in at least one of a certain area that is away from a deployment area of the ramp in the vehicle forward direction and a certain area that is away from the deployment area of the ramp in the vehicle rearward direction, wherein the controller
detects an approaching moving body approaching the deployment area of the ramp and determines the moving velocity of the approaching moving body based on the results of sensing by the sensor, and
stops the operation of deploying the ramp when, after the start of the operation of deploying the ramp, the controller detects the approaching moving body having a moving velocity higher than or equal to a predetermined reference velocity with which the approaching moving body may reach the deployment area of the ramp during the operation of deploying the ramp.

2. The ramp-equipped vehicle according to claim 1, wherein the controller
further controls the operation of storing the ramp, and
stops the operation of deploying the ramp and then starts the operation of storing the ramp when the controller detects the approaching moving body having a moving velocity higher than or equal to another predetermined reference velocity higher than the reference velocity during the operation of deploying the ramp.

3. The ramp-equipped vehicle according to claim 1, further comprising a speaker that is positioned on an outer surface of the vehicle body so as to output a sound toward at least one of the certain area that is away from the deployment area of the ramp in the vehicle forward direction and the certain area that is away from the deployment area of the ramp in the vehicle rearward direction, wherein
the controller generates a beep sound from the speaker when it detects the approaching moving body having a moving velocity higher than or equal to the reference velocity during the operation of deploying the ramp.
